(19) United States
(12) Patent Application Publication
(10) Pub. No.: US 2024/0429453 A1
(43) Pub. Date: Dec. 26, 2024

(54) EXPANDED TEMPERATURE RANGE ELECTROLYTES FOR LITHIUM-ION BATTERIES USING SULFONE EUTECTIC MIXTURES

(71) Applicants: Candace Chan, Phoenix, AZ (US); Mulki Harish Bhat, Chandler, AZ (US); Charles Austen Angell, Mesa, AZ (US)

(72) Inventors: Candace Chan, Phoenix, AZ (US); Mulki Harish Bhat, Chandler, AZ (US); Charles Austen Angell, Mesa, AZ (US)

(21) Appl. No.: 18/743,733

(22) Filed: Jun. 14, 2024

Related U.S. Application Data
(60) Provisional application No. 63/509,606, filed on Jun. 22, 2023.

(51) Int. Cl. H01M 10/0569; H01M 10/0525

(52) U.S. Cl. CPC H01M 10/0569; H01M 10/0525; H01M 2300/0042

(57) ABSTRACT

Expanded temperature range electrolytes for lithium-ion batteries using sulfone eutectic mixtures include 1 wt % to 5 wt % of a first component that includes vinylene carbonate (VC); and 95 wt % to 99 wt % of a second component that includes a 0.5 M to 1.5 M solution of LiPF₆ in a mixture that includes ethyl methyl sulfone (EMS); dimethyl sulfone (DMS); ethylene carbonate (EC); and ethyl methyl carbonate (EMC). A ratio of a total weight of EMS and DMS to a total weight of EC to a total weight of EMC is in a range of 1:1:5 to 2:2:10, and the EMS and DMS are present in a ratio of 80 mol % to 90 mol % of EMS to 20 mol % to 10 mol % of DMS.

### CROSS-REFERENCE TO RELATED APPLICATION

This application claims the benefit of U.S. Patent Application No. 63/509,606 filed on Jun. 22, 2023, which is incorporated herein by reference in its entirety.

### TECHNICAL FIELD

This invention relates to electrolyte compositions including eutectic mixtures of sulfone solvents that provide consistent performance in lithium-ion batteries over a wide temperature range.

### BACKGROUND

The high energy density and power characteristics of lithium-ion batteries make them advantageous for energy storage technology. However, lithium-ion batteries perform poorly at extreme temperatures. Possible reasons for the poor performance of lithium-ion batteries at temperature extremes relate to the electrolyte typically used in the batteries. Characteristics of the electrolyte that can lead to deteriorated performance include changes in viscosity, crystallization status (e.g., freezing at low temperatures), ionic conductivity, and degradation of the salt and/or solvent components of the electrolytes (particularly at high temperatures).

FIG. 1A depicts an example of a lithium-ion battery (LIB) 100. LIB 100 has anode 102 and cathode 104. Anode 102 and cathode 104 are separated by separator 106. Anode 102 includes anode collector 108 and anode material 110 in contact with the anode collector. Cathode 104 includes cathode collector 112 and cathode material 114 in contact with the cathode collector. Electrolyte 116 is in contact with anode material 110 and cathode material 114. Anode collector 108 and cathode collector 112 are electrically coupled via closed external circuit 118. Anode material 110 and cathode material 114 are materials into which, and from which, lithium ions 120 can migrate. During insertion (or intercalation) lithium ions move into the electrode (anode or cathode) material. During extraction (or deintercalation), the reverse process, lithium ions move out of the electrode (anode or cathode) material. When a LIB is discharging, lithium ions are extracted from the anode material and inserted into the cathode material. When the cell is charging, lithium ions are extracted from the cathode material and inserted into the anode material. The arrows in FIG. 1A depict movement of lithium ions through separator 106 during charging and discharging. FIG. 1B depicts device 130 including LIB 100. Device 130 may be, for example, an electric vehicle, an electronic device (e.g., a portable electronic device such as a cellular telephone, a tablet or laptop computer, etc.), or the like.

### SUMMARY

This disclosure describes lithium-ion battery electrolyte compositions that exhibit consistent performance parameters throughout a range of temperatures. The electrolyte compositions use eutectic mixtures of sulfones to provide a solvent with a high dielectric constant to solvate lithium ions and a low liquidus temperature for use at low temperatures. The electrolyte compositions can include nitriles and organic carbonates to lower the viscosity, increase the dielectric constant, and further lower the liquidus temperature. Sulfones can be added to provide better anionic stability and sulfites can increase conductivity at low temperatures. The electrolyte compositions can include additives to passivate the anode surface, creating solid electrolyte interface (SEI) layers, and promote wetting of the separator.

In a first general aspect, an expanded temperature range electrolyte for lithium-ion batteries using sulfone eutectic mixtures include 1 wt % to 5 wt % of a first component that includes vinylene carbonate (VC); and 95 wt % to 99 wt % of a second component that includes a 0.5 M to 1.5 M solution of LiPF₆ in a mixture that includes ethyl methyl sulfone (EMS); dimethyl sulfone (DMS); ethylene carbonate (EC); and ethyl methyl carbonate (EMC). A ratio of a total weight of EMS and DMS to a total weight of EC to a total weight of EMC is in a range of 1:1:5 to 2:2:10, and the EMS and DMS are present in a ratio of 80 mol % to 90 mol % of EMS to 20 mol % to 10 mol % of DMS.

Implementations of the general aspect may include one or more of the following features.

The electrolyte includes 2 wt % of the first component and 98 wt % of the second component. The second component includes a 1 M solution of LiPF₆ in the mixture. A ratio of EMS to DMS is 85:15 mol/mol. A total volume of EMS and DMS to the total volume of EC is 1:1. A ratio of the total volume of EMS and DMS to the total volume of EMC is 1.5:7 wt/wt. A ratio of the total weight of EC to EMC is 1.5:7. In some cases, the mixture includes a wetting agent (e.g., a fluorinated ether, such as 1,1,2,2-tetrafluoroethyl-2,2,3,3-tetrafluoropropyl ether.

In a second general aspect, a lithium-ion battery includes the electrolyte of the first general aspect.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A and 1B depict a lithium-ion battery and a device including a lithium-ion battery, respectively.

FIG. 2A depicts the chemical structure dimethyl sulfone (DMS) and ethyl methyl sulfone (EMS). FIG. 2B depicts the phase diagram for a eutectic mixture of DMS and EMS. FIG. 2C depicts the effects of salt additives on the melting temperature of the eutectic mixture.

FIG. 3 illustrates the chemical structures of lithium salts used to make the electrolyte compositions.

FIG. 4 illustrates the chemical structures of sulfones used to make the electrolyte compositions.

FIG. 5 illustrates the chemical structures of carbonates used to make the electrolyte compositions.

FIG. 6 illustrates the chemical structures of sulfites used to make the electrolyte compositions.

FIG. 7 illustrates the chemical structures of nitriles used to make the electrolyte compositions.

FIG. 8 illustrates the chemical structure of 1,1,2,2-tetrafluoroethyl-2,2,3,3-tetrafluoropropyl ether (TTE).

FIG. 9 is a differential scanning calorimetry plot.

FIG. 10 is a Nyquist plot from an electrochemical impedance spectroscopy measurement used to determine ionic conductivity.

FIG. 11 is a plot of voltage versus capacity used to assess electrolyte performance in batteries.

FIG. 12 is a plot of conductivity versus temperature for selected electrolyte compositions.

FIG. 13 is a plot of conductivity versus temperature for selected electrolyte compositions.

FIG. 14 is a plot of conductivity versus temperature for selected electrolyte compositions.

FIG. 15 is a plot of average first cycle coulombic efficiency for selected electrolyte compositions.

FIG. 16 is a plot of the discharge capacity of NCA/graphite pouch cells (nominal capacity 200 mAh) with various electrolyte compositions measured at −20° C. for several discharge rates.

FIG. 17 shows the discharge capacity of NCA/graphite pouch cells (nominal capacity 200 mAh) with a select electrolyte obtained at several discharge rates at room temperature and at −20° C.

FIG. 18 shows the discharge capacity of NCA/graphite pouch cells in various electrolytes obtained at several discharge rates at room temperature and at −20° C.

FIG. 19 shows the discharge capacity of NCA/graphite pouch cells in various electrolytes obtained at several discharge rates at room temperature and at −20° C.

FIG. 20 shows the discharge capacity of NCA/graphite pouch cells in various electrolytes obtained at several discharge rates at room temperature and at −20° C.

FIG. 21 shows the discharge capacity of NCA/graphite pouch cells in various electrolytes obtained at several discharge rates at room temperature and at −20° C.

FIG. 22 shows the location of pouch cell thickness measurements.

FIG. 23 is a plot of the capacity retention (measured at room temperature) for NCA/graphite pouch cells (nominal capacity 200 mAh) with various electrolyte compositions after storage at 100% SOC at +60° C.

FIG. 24 is a plot of the average thickness increase of the pouch cells measured from the center for cells with various electrolyte compositions after storage at 100% SOC at +60° C.

FIG. 25 is a plot of the discharge voltage profiles measured at room temperature for pouch cells with a select electrolyte after storage at 100% SOC at +60° C.

FIG. 26 is a plot of the discharge voltage profiles measured at room temperature for pouch cells with a select electrolyte after storage at 100% SOC at +60° C.

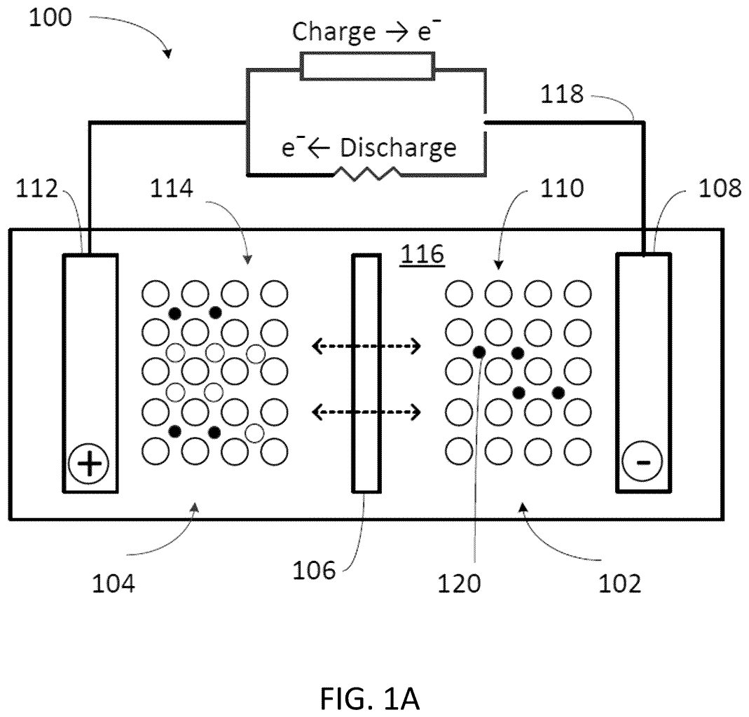

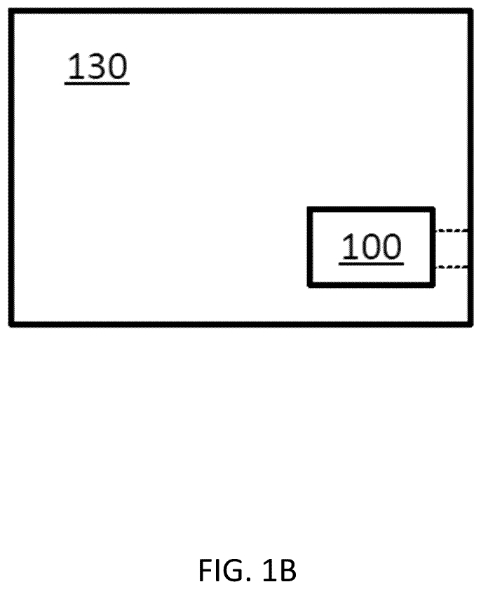

### DETAILED DESCRIPTION

This disclosure describes electrolyte compositions that facilitate improved lithium-ion battery performance at extreme temperatures. The electrolyte compositions include eutectic mixtures of sulfones with viscosity-lowering co-solvents, thermally stable salts, and solid electrolyte interface film forming additives as components that make the electrolytes effective at extreme temperatures. The electrolytes support applications in which a single type of battery is used in conditions encompassing a range of temperatures. The lithium-ion battery electrolytes provide the same or better performance at 24° C. and cold temperatures (down to −20° C.) and exhibit the same or lower storage losses and internal resistance at 24° C. during storage at high temperatures (up to 60° C.) when compared to carbonate-based electrolytes.

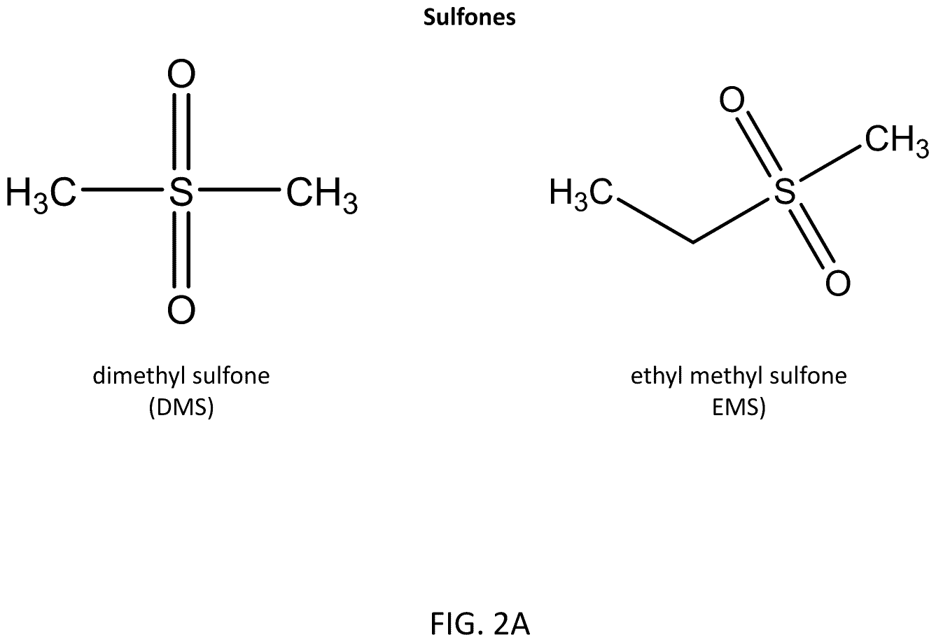

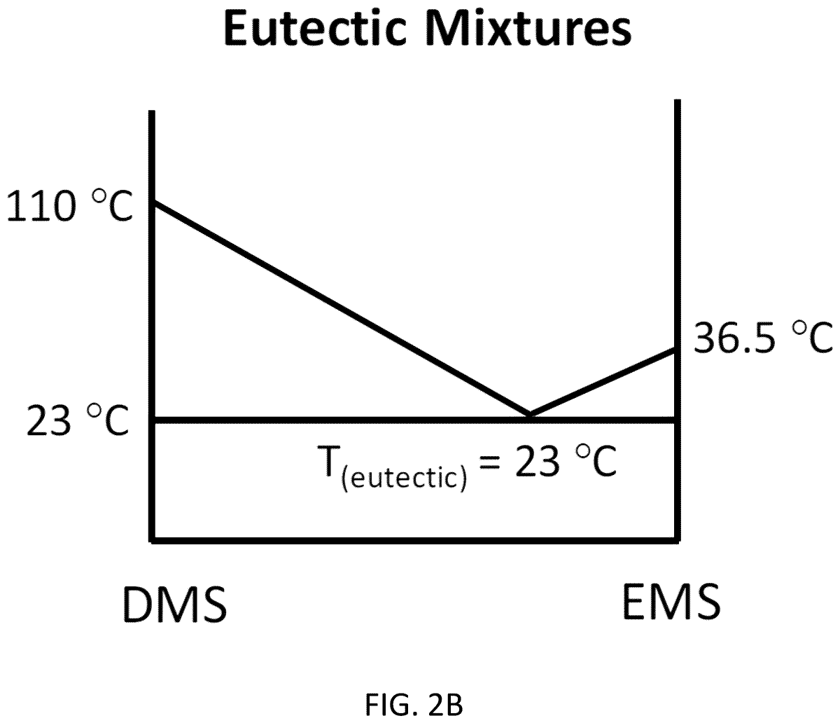

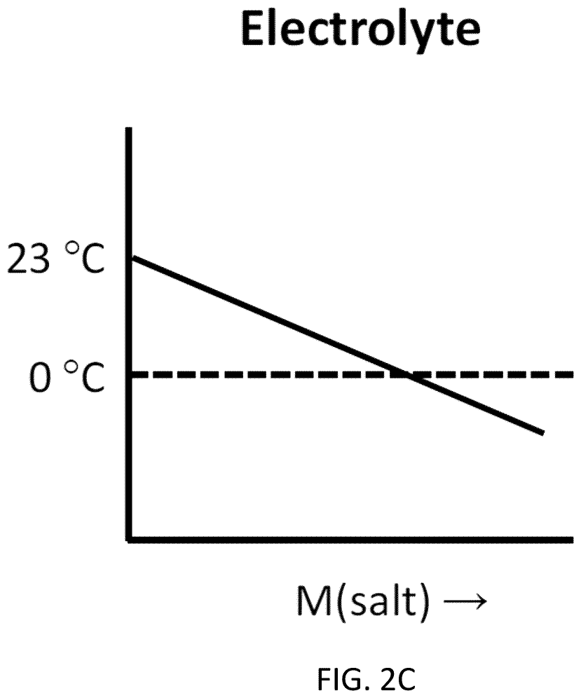

The electrolytes include a eutectic mixture of two linear sulfone compounds illustrated in FIG. 2A. The sulfones, dimethyl sulfone (DMS) and ethyl methyl sulfone (EMS), have high dielectric constants (¿=48 and 65, respectively), and thus can effectively solvate lithium ions, but have unfavorably high melting points (Tₘ=110 and 35° C., respectively). Mixing DMS and EMS forms a liquid that is stabilized by the entropy of mixing. In one example, a mixture of DMS and EMS at a molar ratio of 15:85 has a eutectic temperature of 23° C., as shown in FIG. 2B. Upon addition of the lithium salt and a co-solvent (e.g., dimethylcarbonate, DMC, η=0.58) to reduce the viscosity, the liquidus range of the electrolyte can be further expanded to lower temperatures, as shown in FIG. 2C.

The electrolyte compositions can include the core salt-dissolving DMS/EMS solvent combined with organic carbonates (e.g., ethyl methyl carbonate (EMC), ethylene carbonate (EC), vinylene carbonate (VC), fluoroethylene carbonate (FEC), propylene carbonate (PC), dimethyl carbonate (DMC), and diethyl carbonate (DEC)). The organic carbonates can be used to lower the viscosity and increase the dielectric constant of the electrolyte compositions.

The electrolyte compositions can include sulfites (e.g., diethyl sulfite (DESt) and dimethyl sulfite (DMSt)). The addition of sulfites provides better anodic stability and higher ionic conductivity at lower temperatures.

The electrolyte compositions can include nitriles (e.g., acetonitrile (AN), propionitrile (PN), and butyronitrile (BN)). Nitriles exhibit a low melting point, low viscosity, and a high dielectric constant which are advantageous properties for the electrolyte compositions. The higher dielectric constants of the nitriles enable the electrolyte to maintain a high ionicity.

Additives including vinylene carbonate (VC), fluoroethylene carbonate FEC), methyl vinyl sulfone (MVS), and ethyl vinyl sulfone (EVS) can be added for passivating the anode surface and creating solid electrolyte interface (SEI) layers. The electrolyte compositions can include fluorinated ethers (e.g., 1,1,2,2-tetrafluoroethyl-2,2,3,3-tetrafluoropropyl ether), which have a low melting point, high oxidation stability, and non-flammability. The fluorinated ethers can aid wetting to the separator.

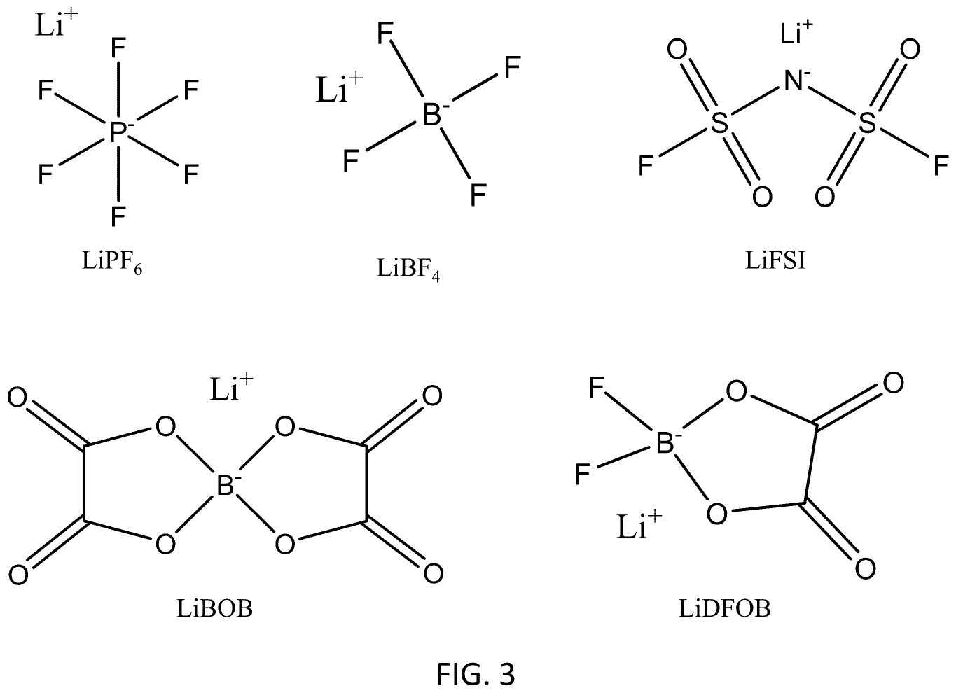

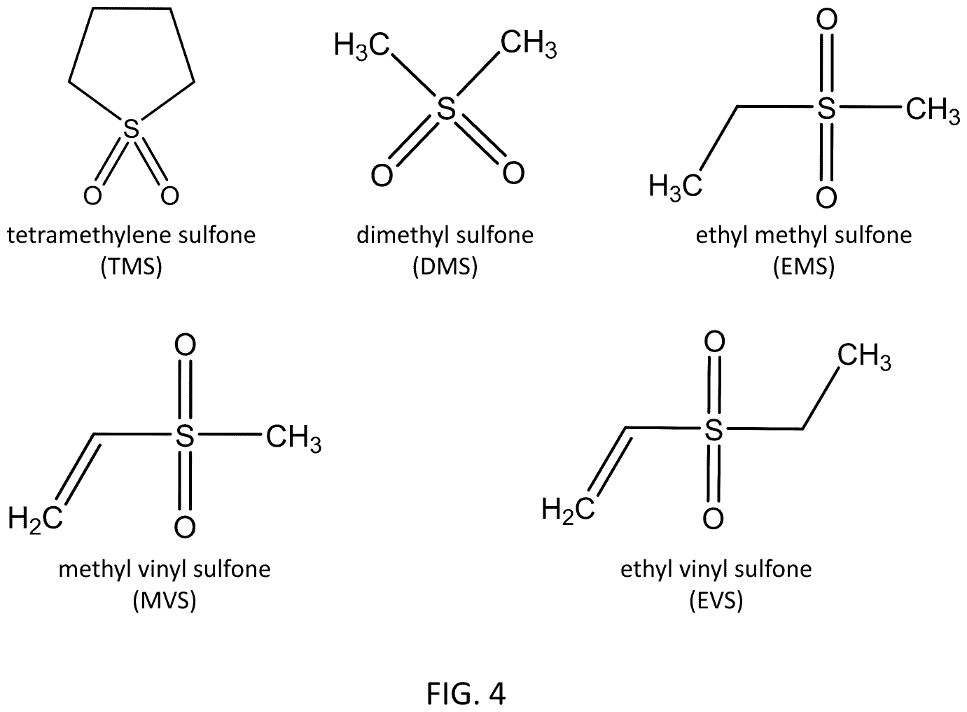

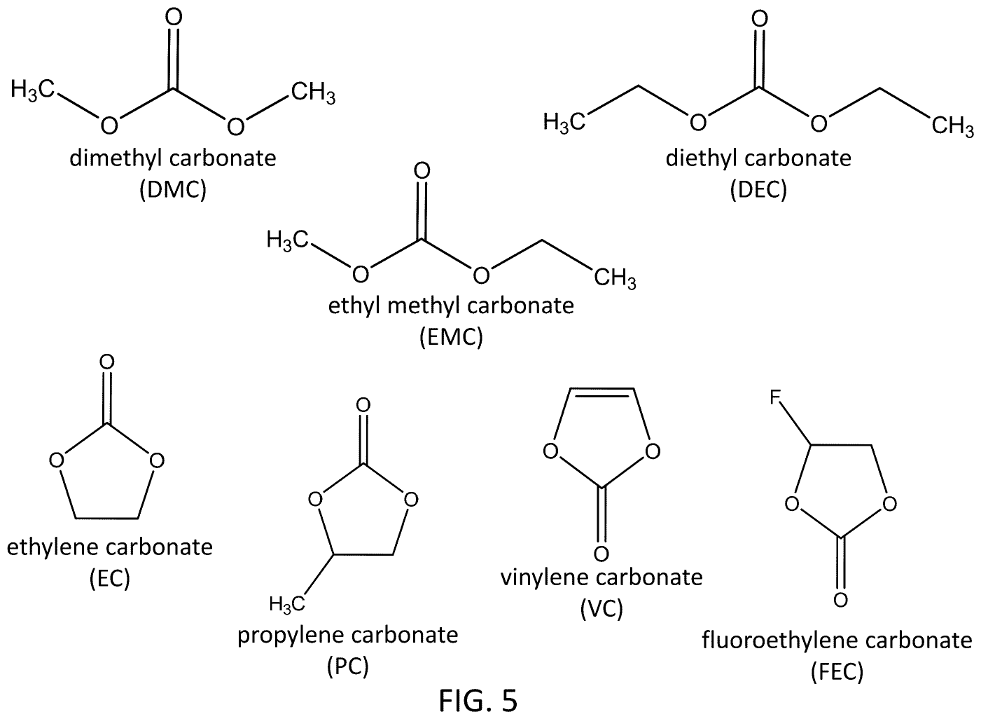

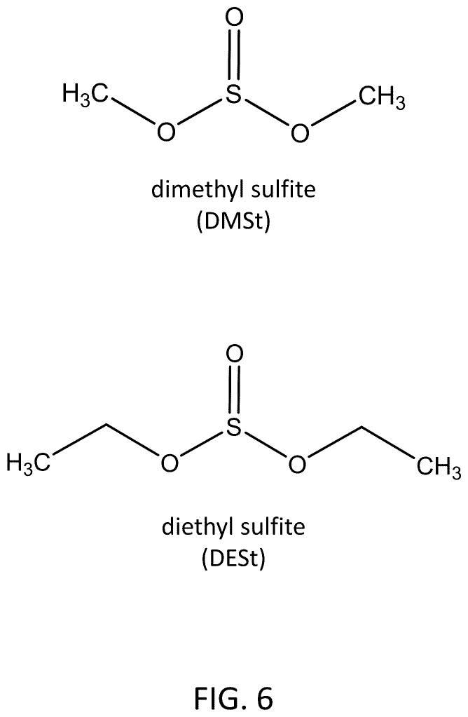

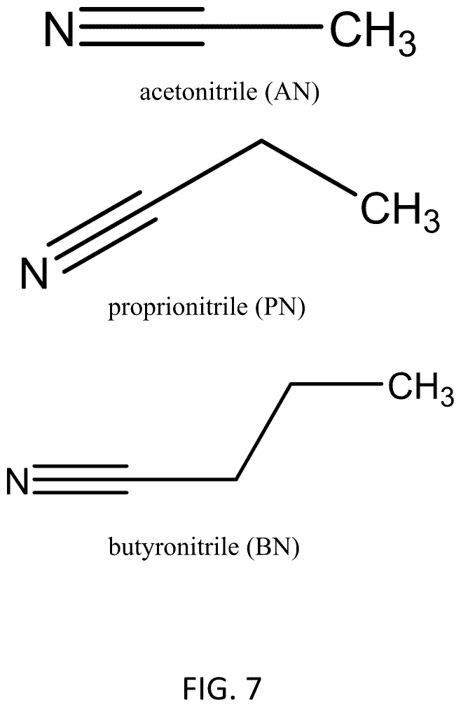

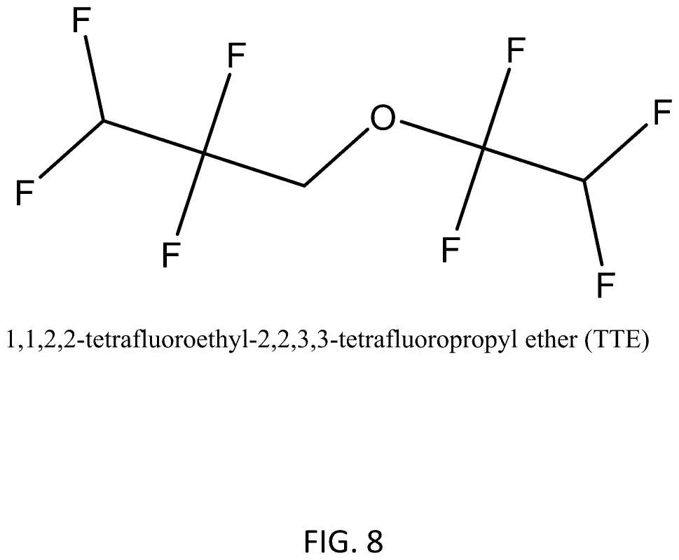

FIGS. 3-8 show chemical structures of various components in the disclosed electrolytes. FIG. 3 shows the following lithium salts: lithium hexafluorophosphate (LiPF₆), lithium bis(fluorosulfonyl)imide (LiFSI), lithium bis(oxalate)borate (LiBOB), lithium tetrafluoroborate (LiBF₄), and lithium difluoro (oxalate)borate (LiDFOB). FIG. 4 shows the following sulfones: ethyl methyl sulfone (EMS), dimethyl sulfone (DMS), tetramethylene sulfone (TMS), methyl vinyl sulfone (MVS), and ethyl vinyl sulfone (EVS). FIG. 5 shows the following carbonates: ethyl methyl carbonate (EMC), ethylene carbonate (EC), vinylene carbonate (VC), fluoroethylene carbonate (FEC), propylene carbonate (PC), dimethyl carbonate (DMC), and diethyl carbonate (DEC). FIG. 6 shows the following sulfites: diethyl sulfite (DESt), and dimethyl sulfite (DMSt). FIG. 7 shows the following nitriles: butyronitrile (BN), propionitrile (PN), acetonitrile (AN). FIG. 8 shows the chemical structure of 1,1,2,2-tetrafluoroethyl-2,2,3,3-tetrafluoropropyl ether (TTE). Physicochemical properties of selected solvents are listed in Table 1.

TABLE 1
Solvent/co-solvents with melting point (Tₘ,° C.), boiling point (T_{b},° C.),
dielectric constant (ε), and viscosity (η, mPa s) at 25° C.

| Molecule | Abbreviation | Tₘ | T_{b} | ε | η |
|---|---|---|---|---|---|
| Ethylene carbonate | EC | 39.6 | 248 | 90.36 | 2.5 |
| Ethyl methyl carbonate | EMC | −53 | 110 | 2.958 | 0.65 |
| Dimethyl carbonate | DMC | 4.6 | 90 | 3.09 | 0.58 |
| Diethyl carbonate | DEC | −74.3 | 126 | 2.82 | 0.75 |
| Propylene carbonate | PC | −48.8 | 242 | 65 | 2.53 |
| Tetramethylene sulfone | TMS | 28.5 | 285 | 43.3 | 10.3 |
| (also known as Sulfolane) | | | | | |
| Dimethyl sulfone | DMS | 110 | 238 | 48 | i |
| Ethyl methyl sulfone | EMS | 35 | 239 | 65 | ii |
| Dimethyl sulfite | DMSt | −141 | 126 | 22.5 | 0.87 |
| Diethyl sulfite | DESt | −112 | 159 | 15.6 | 0.58 |
| 1,1,2,2-Tetrafluoroethyl- | TTE | ii | 92 | 6.4 | ii |
| 2,2,3,3- | | | | | |
| tetrafluoropropyl ether | | | | | |
| Acetonitrile | AN | −46 | 81 | 35.8 | 0.33 |
| Propionitrile | PN | −97.8 | 97.2 | 27.7 | ~0.7 |
| Butyronitrile | BN | −111 | 118 | 20.7 | 0.553 |
| Gamma butyrolactone | GBL | −43 | 204 | 41.75 | 1.75 |
| Dimethyl formamide | DMF | −77.8 | 153 | 77.3 | ~1 |
| Ethyl acetate | EA | −83.6 | 77.1 | ii | 0.455 |
| Ethyl cyanoacetate | ECA | −22 | 208 | 19.3 | ii |
| 2-Methyltetrahydrofuran | MTHF | −136 | 80.2 | 7.43 | 0.459 |

(i The viscosity at 123° C. is reported as 1.14 mPa s; ii Not known)

### Electrolyte Compositions

The electrolyte compositions demonstrate advantageous performance with respect to coulombic efficiency at room temperature, discharge capacity at low temperature (e.g., −20° C.), and storage and discharge performance at high temperature (e.g., +60° C.). The following electrolytes were prepared with the specified mixtures of solvents, salts and additives, and the resulting electrolyte(s) were tested under various conditions (e.g., discharge at −20° C., discharge at room temperature and after storage at +60° C.). In the electrolyte compositions listed below, solvent A is (85 mol % EMS: 15 mol % DMS).

Electrolyte 2. 1M LiPF₆ in (3 solvent A:7 EMC) (wt:wt).

Electrolyte 7. 1M LiPF₆ in (3 solvent A:3.5 EMC:3.5 DESt) (wt:wt:wt).

Electrolyte 11. 1M LiPF₆ in (3 solvent A:3.5 EMC:3.5 DMSt) (wt:wt:wt).

Electrolyte 12. 1M LiPF₆ in (2.5 solvent A:0.5 EC:3.5 EMC:3.5 DMSt) (wt:wt:wt:wt).

Electrolyte 13. 98 wt % of [1M LiPF₆ in (3 solvent A:3.5 EMC:3.5 DMSt) (wt:wt:wt)] combined with 2 wt % VC.

Electrolyte 14. 98 wt % of [1M LiPF₆ in (3 solvent A:7 EMC) (wt:wt)] combined with 2 wt % VC.

Electrolyte 15. 98 wt % of [1M LiPF₆ in (2.5 solvent A:0.5 EC:3.5 EMC:3.5 DMSt) (wt:wt:wt:wt)] combined with 2 wt % VC.

Electrolyte 16. 98 wt % of [1M LiPF₆ in (2.5 solvent A:0.5 EC:7 solvent EMC) (wt:wt:wt)] combined with 2 wt % VC.

Electrolyte 21. 1M LiPF₆ in (3 solvent A:7 BN) (wt:wt).

Electrolyte 22. 98 wt % of [1M LiPF₆ in (3 solvent A:6 BN: 1 EC) (wt:wt:wt)] combined with 2 wt % VC.

Electrolyte 23. 98 wt % of [1M LiPF₆ in (1.5 solvent A:1.5 EC:7 EMC) (wt:wt:wt)] combined with 2 wt % VC.

Electrolyte 24. 98 wt % of [1M LiPF₆ in (1.5 solvent A:1.5 EC:3.5 BN: 3.5 EMC) (wt:wt:wt:wt)] combined with 2 wt % VC.

Electrolyte 26. 1M LiPF₆ in (3 solvent A:7 EMC:3 TTE) (wt:wt:wt)

Electrolyte 27. 1M LiFSI in (3 solvent A:7 EMC:3 TTE) (wt:wt:wt)

Electrolyte 30. 98 wt % of [1M LiPF₆ in (3 solvent A:7 EMC:3 TTE) (wt:wt:wt)] combined with 2 wt % VC.

Electrolyte 33. 1M LiFSI in (3 EC:7 EMC) (wt:wt).

Electrolyte 34. 98 wt % of {98 wt % of [1M LiPF₆ in (1.5 solvent A:1.5 EC:7 EMC) (wt:wt:wt)] combined with 2 wt % VC} combined with 3 wt % TTE.

Electrolyte 34x. 76.4 wt % of {98 wt % of [1M LiPF₆ in (1.5 solvent A:1.5 EC:7 EMC) (wt:wt:wt)] combined with 2 wt % VC} combined with 23.6 wt % TTE.

Electrolyte 35. 98 wt % of {98 wt % of [1M LiPF₆ in (1.5 solvent A:1.5 EC:7 EMC) (wt:wt:wt)] combined with 2 wt % VC} combined with 5 wt % TTE.

Electrolyte 36. 98 wt % of [1M LiODFB in (1.5 solvent A:1.5 EC:7 EMC) (wt:wt:wt)] combined with 2 wt % VC.

Electrolyte 37. 98 wt % of [1M LiFSI in (1.5 solvent A:1.5 EC:7 EMC) (wt:wt:wt)] combined with 2 wt % VC.

Electrolyte 38. 98 wt % of [1.2M LiFSI in (1.5 solvent A:1.5 EC:7 EMC) (wt:wt:wt)] combined with 2 wt % VC.

Electrolyte 39. 98 wt % of {98 wt % of [1M LiPF₆ in (1.5 solvent A:1.5 EC:7 EMC) (wt:wt:wt)] combined with 2 wt % VC} combined with 2 wt % FEC.

### Electrolyte Characterization

To characterize the electrolyte properties, the following tests were performed.

Wettability properties were assessed by applying a drop of electrolyte to a Celgard 2500 separator and visually inspecting the wetting after 10 mins.

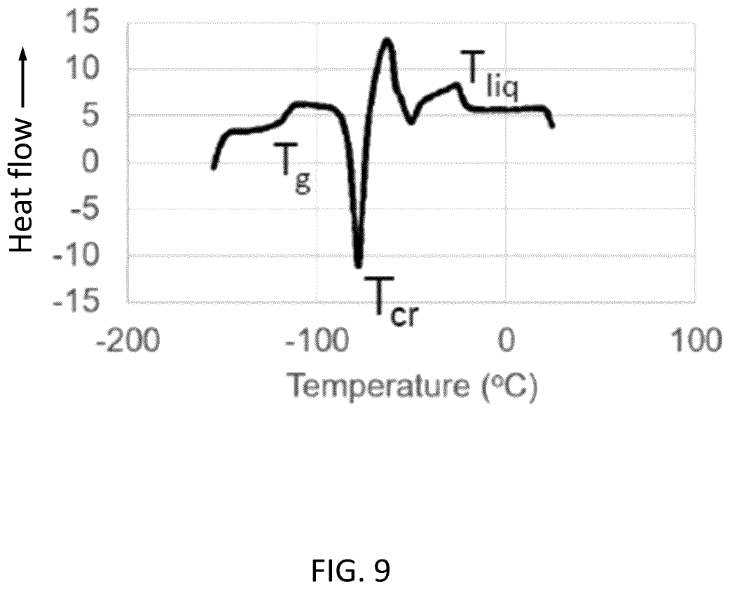

Thermal properties were characterized using differential scanning calorimetry (DSC) to determine liquidus temperature (T_{liq}), glass transition temperature (T_{g}), and crystallization temperature (T_{cr}), as shown in FIG. 9.

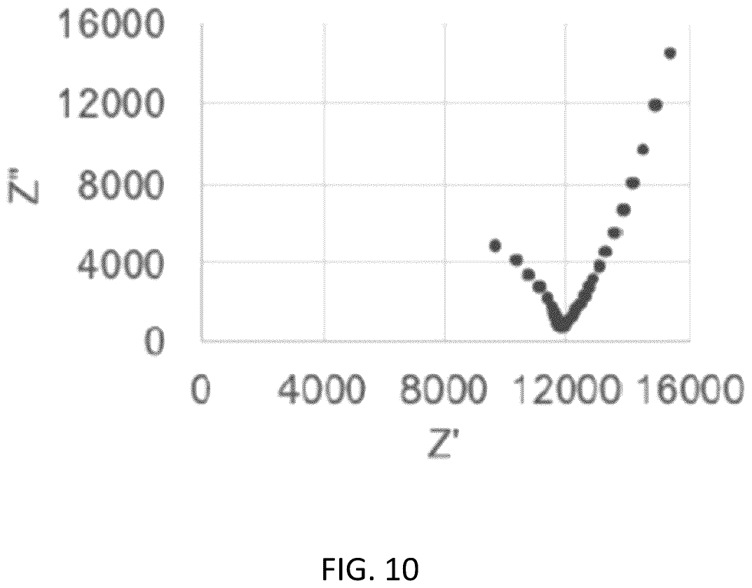

Ionic conductivity was determined using electrochemical impedance spectroscopy (EIS) using platinum electrodes between a temperature range of approximately −60° C. to +60° C., as shown in FIG. 10. A mixture of dry ice and acetone was used for low temperature conductivity measurements, while an oil bath was used for determining the same from room temperature to +60°.

Long term low temperature storage was assessed by placing a small quantity of electrolyte in a sealed vial which was stored in a −39° C. freezer inside an argon glovebox.

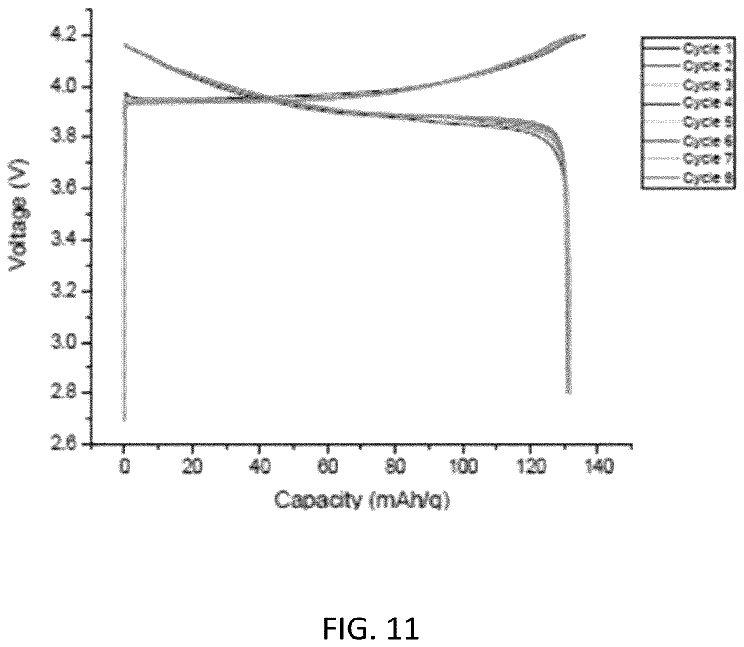

Initial electrochemical cycling performance of the electrolytes was assessed in 2032-type coin cells containing lithium nickel cobalt aluminum oxide (NCA) cathodes and graphite anodes as shown in FIG. 11. Coin cells were cycled at room temperature with increasing discharge rates. Low temperature performance was assessed by charging at room temperature and discharging at −20° C. at different rates.

Electrolytes were evaluated in pouch cells. Dry NCA/graphite pouch cells containing no electrolyte were purchased from Lifun with capacity of 200 mAh. The disclosed electrolytes were added to the pouch cells. The pouch cells were evaluated in a similar manner as described for the coin cells. Additionally, pouch cells were subjected to high temperature storage tests, where fully charged pouch cells were stored at +60° C. and then discharged at room temperature to assess the amount of retained capacity. The dimensional change in the pouch cells due to swelling (e.g., from electrolyte decomposition and gas generation) was also assessed after the high temperature storage.

Table 2 lists liquidus temperature (T_{liq}), glass transition temperature (T_{g}), and crystallization temperature determined (T_{cr}) of selected electrolyte compositions. The melting point of sulfones can be decreased by adding a linear carbonate such as DMC or EMC. Adding VC can improve the SEI-forming properties and lower T_{liq}. Table 3 lists the liquidus temperature for selected electrolyte compositions.

TABLE 2
Thermal properties of selected electrolyte compositions

| | Solvent Composition | T_{g} | T_{cr} | T_{liq} |
|---|---|---|---|---|
| # | (with 1M LiPF₆) | (° C.) | (° C.) | (° C.) |
| 20 | 85 EMS − 15 DMS | −73.4 | none | >Te = 23 |
| | (mol %) | | | |
| 10 | 1 EMS:1 DMC (w/w) | −95 | −69, −39 | −13.9, −1.8 |
| 9 | 1 (85 EMS − 15 DMS): | −87 | −50, −27 | −12.4 |
| | 1 DMC (w/w) | | | |
| 1 | 3 (85 EMS − 15 DMS): | −83 | none | −2.9 |
| | 7 DMC (w/w) | | | |
| 2 | 3 (85 EMS − 15 DMS): | −121 | −78.3 | −56.7 |
| | 7 EMC (w/w) | | | |
| 14 | 3 (85 EMS − 15 DMS): | −123 | −79 | −59.3 |
| | 7 EMC + 2 wt % VC | | | |
| 16 | 2.5 (85 EMS − 15 DMS): | −121 | −77 | −58.4 |
| | 0.5 EC:7 EMC + 2 wt % | | | |
| | VC | | | |
| 23 | 1.5 (85 EMS − 15 DMS): | −120.6 | −78.5 | −59.6 |
| | 1.5 EC:7 EMC + 2 wt % | | | |
| | VC | | | |
| 28 | 1 (85 EMS − 15 DMS): | −119 | −75.9 | −4.53 |
| | 1 EMC + 2 wt % VC | | | |

TABLE 3
Liquidus temperature of selected electrolyte compositions

| # | Electrolyte Composition | Tₘ (° C.) |
|---|---|---|
| Baseline | 1.2M LiPF₆ in EC:EMC (3.7) | −61, −21, −6.2 |
| 21 | 1M LiPF₆ in 3 (85 EMS − 15 DMS):7 BN | −150 (T_{g}) |
| 22 | 98 wt % (1M LiPF₆ in 3 (85 EMS − 15 DMS): | −148 (T_{g}) |
| | 6 BN:1 EC):2 wt % VC | |
| 23 | 1M LiPF₆ in 1.5 (85 EMS − 15 DMS):1.5 EC: | −59.6 |
| | 7 EMC + 2 wt % VC | |
| 24 | 98 wt % [1M LiPF₆ in 1.5 (85 EMS − 15 DMS): | −6.6 |
| | 1.5 EC:3.5 BN:3.5 EMC]:2 wt % VC | |
| 26 | 1M LiPF₆ in 3 (85 EMS − 15 DMS):7 EMC: | −68 |
| | 3 TTE | |
| 27 | 1M LiFSI in 3 (85 EMS − 15 DMS):7 EMC + | −73.8 |
| | 3% TTE | |
| 28 | 1M LiPF₆ in 1 (85 EMS − 15 DMS):1 EMC + | −4.53 |
| | 2 wt % VC | |
| 30 | 98 wt % (1M LiPF₆ in 3 (85 EMS − 15 DMS): | −22.9 |
| | 7 EMC:3 TTE):2 wt % VC | |
| 33 | 1M LiSFI in 3 EC:7 EMC | −20 |
| 34 | 97 wt % Electrolyte 23 + 3 wt % TTE | −63.2 |
| 34x | 76.4 wt % (98 wt % [1M LiPF₆ in 1.5 | −123 (T_{g}) |
| | (85 EMS − 15 DMS):1.5 EC:7 EMC]: | |
| | 2 wt % VC):23.6 wt % TTE | |
| 35 | 98 wt % (98 wt % [1M LiPF₆ in 1.5 | −63 |
| | (85 EMS − 15 DMS):1.5 EC:7 EMC]:2 wt % | |
| | VC):5% TTE | |
| 36 | 1M LiODFB in 1.5 (85 EMS − 15 DMS): | −61.6 |
| | 1.5 EC:7 EMC | |
| 37 | 98% [1M LiFSI in 1.5 (85 EMS − 15 DMS): | −70 |
| | 1.5 EC:7 EMC] + 2 wt % VC | |
| 38 | 98% [1.2M LiPF₆ in 1.5 (85 EMS − 15 DMS): | −69.8 |
| | 1.5 EC:7 EMC] + 2 wt % VC | |
| 39 | Electrolyte 23 + 2% FEC | −69.4 |

The addition of organic sulfites (e.g., DESt and DMSt) to the electrolyte compositions can facilitate high ionic conductivity at low temperatures. The electrolyte compositions listed in Table 4 showed no obvious signs of crystallization down to their glass transition temperature.

TABLE 4
Glass transition temperature of electrolyte compositions with
added sulfites

| # | Solvent Composition | T_{g} (° C.) |
|---|---|---|
| 7 | 3 (85 mol % EMS − 15 mol % DMS):3.5 EMC: | −127 |
| | 3.5 DESt (w/w) | |
| 11 | 3 (85 mol % EMS − 15 mol % DMS):3.5 EMC: | −127 |
| | 3.5 DMSt (w/w) | |
| 12 | 2.5 (85 mol % EMS − 15 mol % DMS):0.5 EC: | −126.5 |
| | 3.5 EMC:3.5 DMSt | |
| 13 | Electrolyte 11 + 2 wt % VC | −126 |
| 15 | Electrolyte 12 + 2 wt % VC | −125.3 |

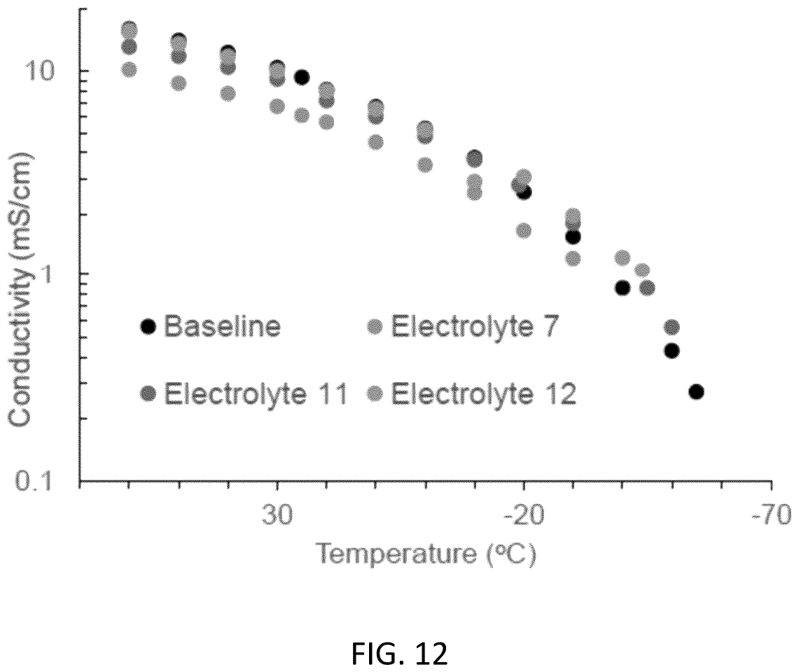

FIG. 12 is a plot of the temperature dependence of the conductivity for select electrolyte compositions listed in Table 4. The plot indicates that DMSt is better than DESt for achieving high ionic conductivity at low temperatures.

Table 5 indicates that the addition of butyronitrile (BN) as a co-solvent to EC and sulfone containing electrolytes results in an extremely low liquidus temperature. No crystallization was observed down to −150° C. for electrolytes 21 and 22.

TABLE 5
Effect of BN on liquidus temperature

| # | Electrolyte Composition | Tₘ (° C.) |
|---|---|---|
| Baseline | 1.2M LiPF₆ in EC:EMC (3:7) | −61, −21, −6.2 |
| 21 | 1M LiPF₆ in 3 (85 EMS − 15 DMS):7 BN | −150 (T_{g}) |
| 22 | 98 wt % (1M LiPF₆ in 3 (85 EMS − 15 DMS): | −148 (T_{g}) |
| | 6 BN:1 EC):2 wt % VC | |
| 24 | 98 wt % [1M LiPF₆ in 1.5 (85 EMS − 15 DMS): | −6.6 |
| | 1.5 EC:3.5 BN:3.5 EMC]:2 wt % VC | |

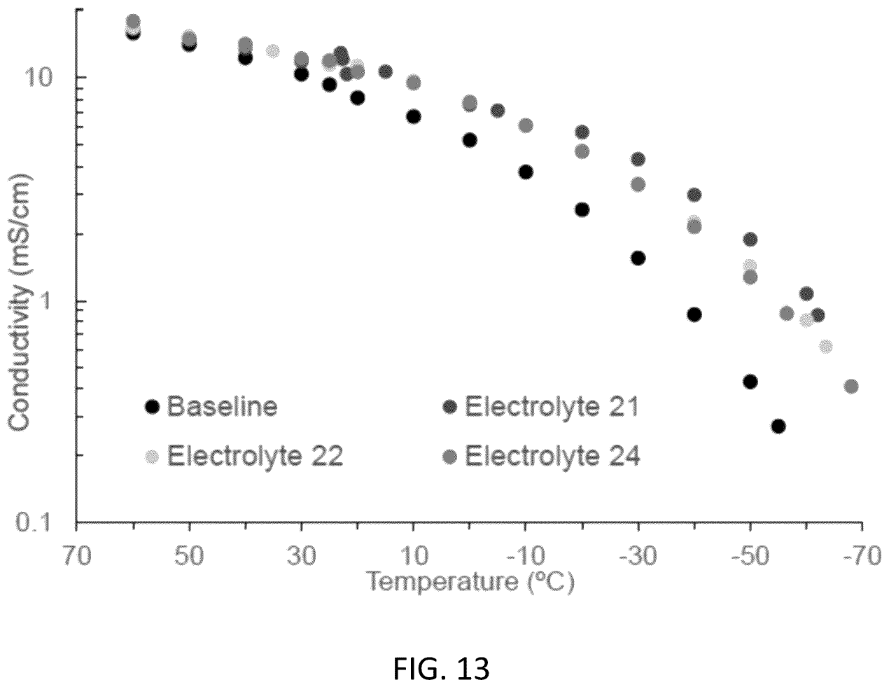

FIG. 13 is a plot of the temperature dependence of the conductivity for the electrolyte compositions listed in Table 5. BN added as a co-solvent to EC and sulfone containing electrolytes results in a higher conductivity at low temperatures compared to the baseline electrolyte.

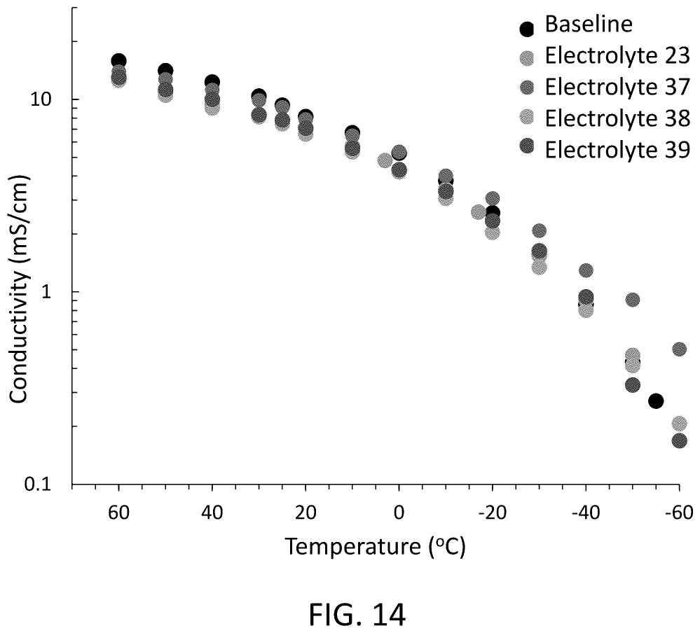

FIG. 14 is a plot of the temperature dependence of the conductivity for select electrolyte compositions listed in Table 3 containing sulfone eutectic mixtures. The plot indicates that at +60° C., the baseline electrolyte shows the high ionic conductivity, while electrolyte compositions 27, 38, and 39 display lower ionic conductivity. At −20° C., electrolyte composition 37 displays the highest ionic conductivity while all of the other electrolytes show lower ionic conductivity and are comparable to each other. At −60° C., electrolyte composition 37 exhibits almost half an order higher conductivity compared to all the other electrolyte compositions. The ionic conductivity of electrolyte composition 37 at −60° C. is approximately 0.5 mS/cm. This result shows that the electrolyte compositions containing sulfones can display higher ionic conductivity at lower temperature compared to the baseline electrolyte composition.

Pouch cells were used to evaluate the performance and stability of the electrolyte compositions. Dry NCA/graphite pouch cells containing no electrolyte were purchased from Lifun with a capacity of 200 mAh and a voltage range of 3.0-4.2 V. The pouches were cut open and dried overnight in a vacuum oven at 120° C. Electrolyte was added, and the pouch was sealed inside a glovebox. Additional sealing was performed using a continuous band sealer outside the glovebox. The pouch cells were conditioned by holding them at 1.5 V for 24 hours, followed by 3 cycles at C/10 (CCCV w/C/50 taper, with one hour rest between charge/discharge). After conditioning, the pouches were cut open for degassing inside the glove box, and again sealed inside the glove box. The pouches were finally sealed using a band sealer as close as possible to the cell stack.

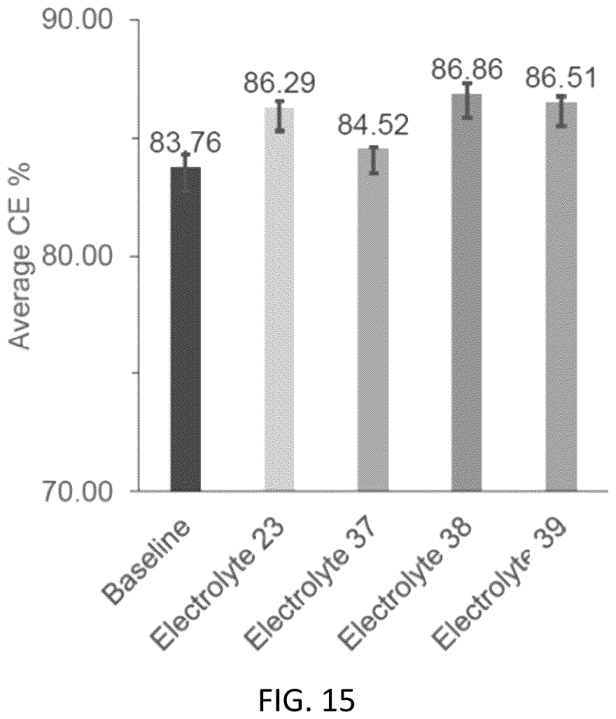

FIG. 15 shows the results of measurements on the first cycle coulombic efficiency (CE %) for the baseline electrolyte composition listed in Table 3 and four test electrolyte compositions. Compositions 23, 38, and 39 have higher first cycle CE % compared to the baseline composition, indicating the formation of a better solid electrolyte interface (SEI) and/or cathode-electrolyte interphase (CEI).

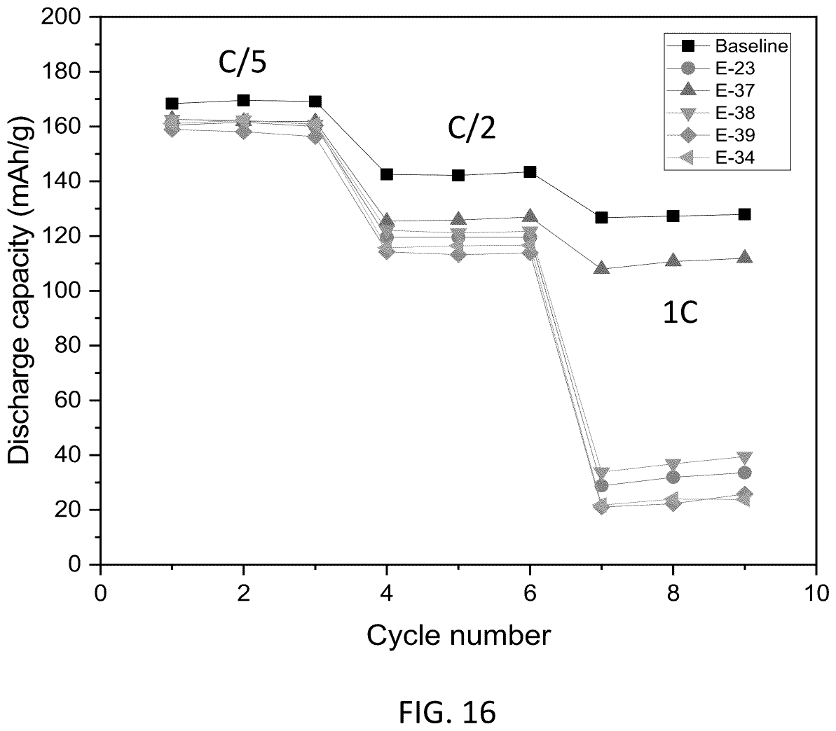

FIG. 16 shows plots of the discharge capacity of pouch cells containing electrolyte compositions 23, 34, 37, 38, and 39 compared with the baseline composition at −20° C. at several discharge rates. The tests were done in the NCA/graphite pouch cells prepared as described previously. The cycling protocol included C/5 charge rate at room temperature and C/5 discharge at −20° C. at different rates, with 3 cycles per C-rate. It can be seen from FIG. 16 that all of the electrolytes have comparable capacity at the C/5 discharge rate. For higher rates, compositions 23, 34, 38, and 39 show greater capacity loss compared to the baseline electrolyte, while electrolyte composition 37 shows only a slighter lower capacity compared to the baseline electrolyte.

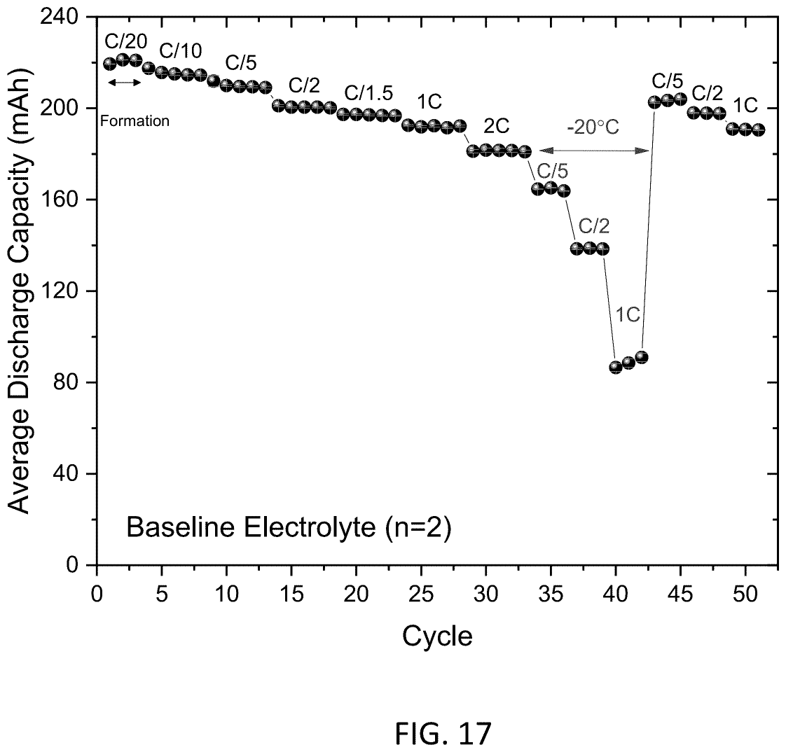

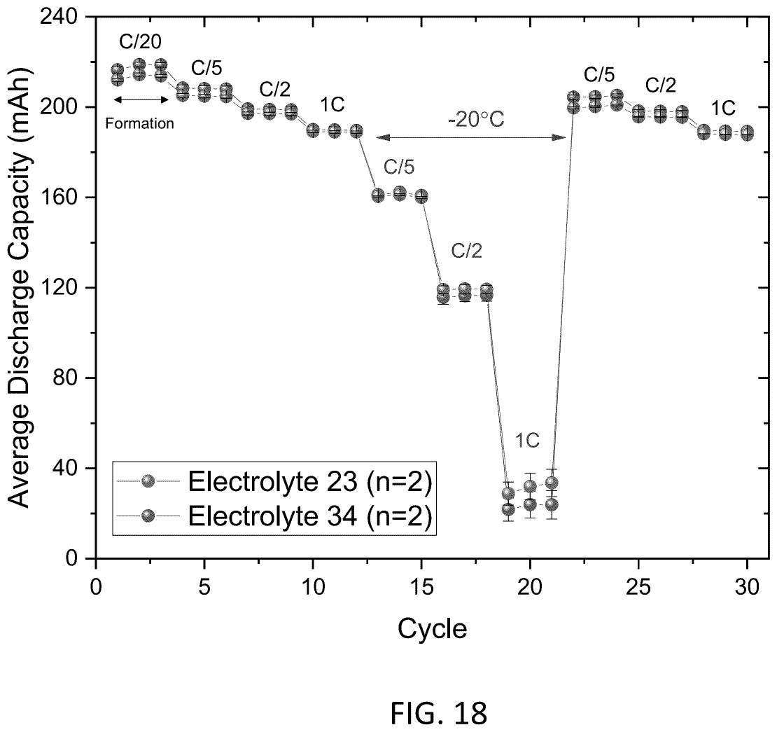

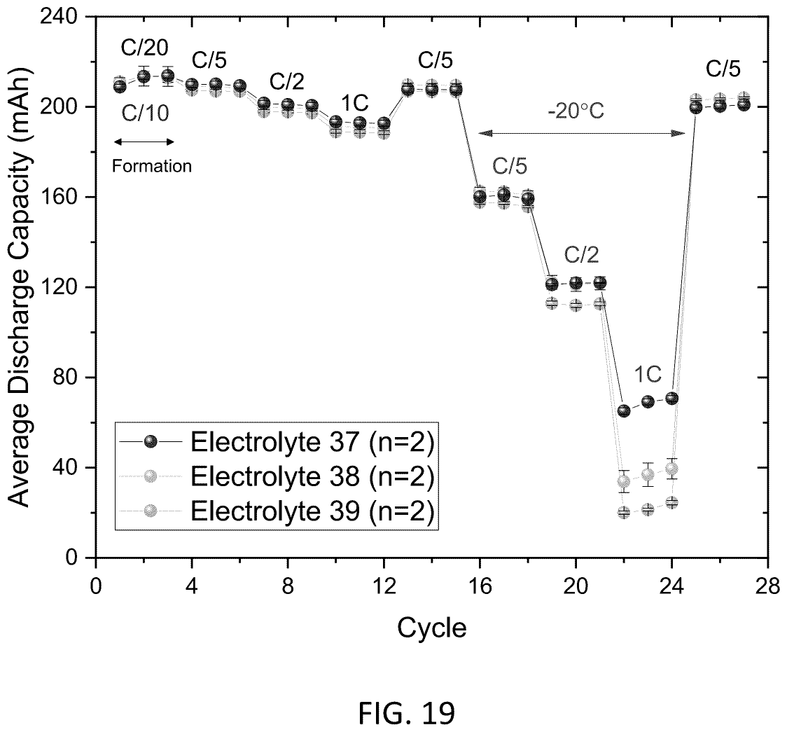

FIGS. 17-19 shows the comparison of the average discharge capacity for NCA/graphite pouch cells containing baseline electrolyte with that of electrolyte compositions 23, 34, 37, 38 and 39 at room temperature and −20° C. The cycling protocol used a C/10 charge rate followed by discharge at different rates measured at room temperature, followed by C/5 charging at room temperature and discharge at −20° C. at different rates. After the discharge was measured at 1C rate at −20° C., the cells were cycled at room temperature with C/10 charge and discharged at different rates. It may be seen that pouch cells containing electrolyte compositions 23, 34, 37, 38, and 39 compare well with the data for those containing the baseline electrolyte composition at room temperature measured with different discharge rates and also for the C/5 rate measured at −20° C. However, for higher discharge rates measured at −20° C., electrolyte compositions 23, 34, 37, 38 and 39 show greater capacity loss compared to the baseline electrolyte composition, with electrolyte composition 37 showing the best capacity retention when discharged at 1C.

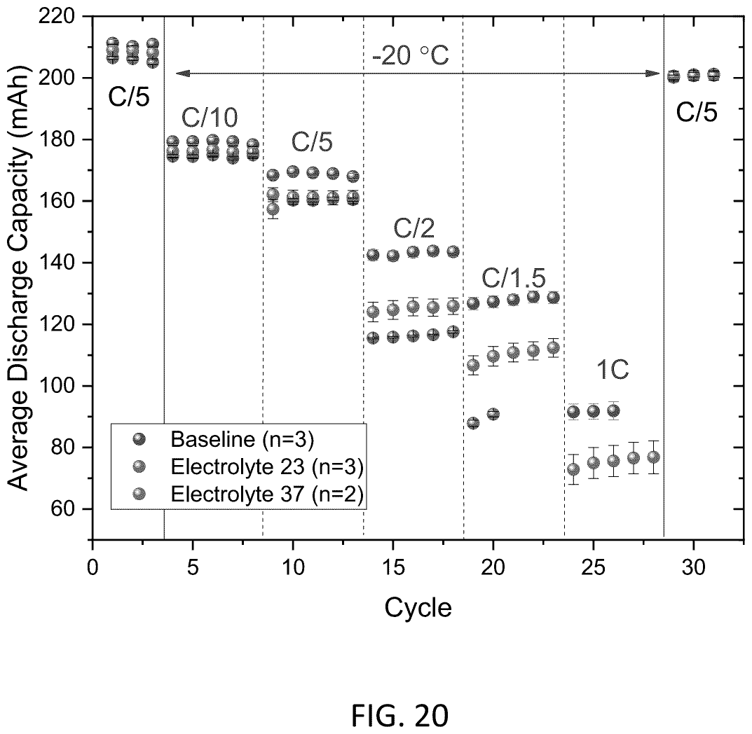

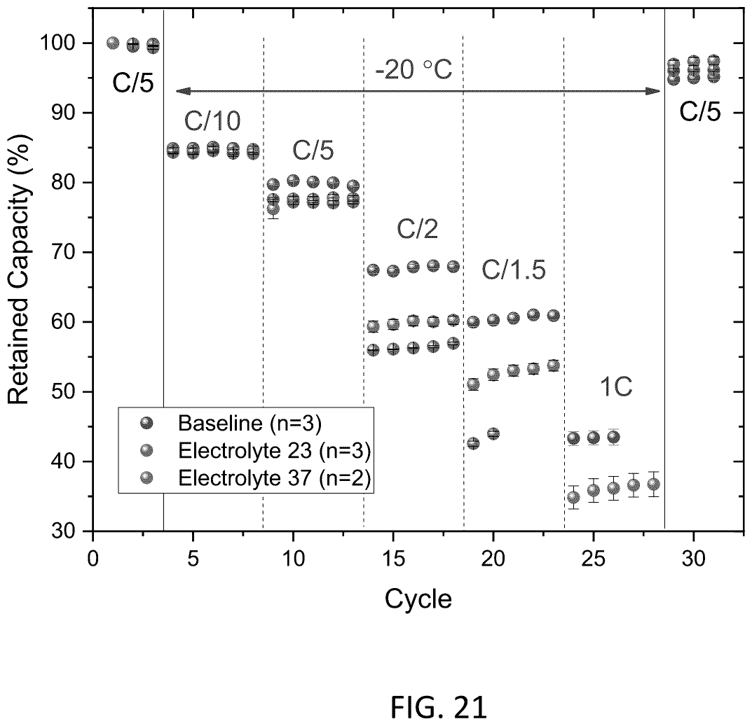

FIG. 20 shows a comparison of the average discharge capacity and FIG. 21 shows the average retained discharge capacity for pouch cells containing the baseline electrolyte composition and electrolyte compositions 23 and 37 measured at different C-rates at room temperature and −20° C. The protocol includes 3 cycles at C/10 charge and C/5 discharge at room temperature before and after the discharges were measured at −20° C. For the −20° C. data, the pouch cells were charged at C/10 at room temperature and discharged at different rates (5 cycles each) at −20° C. From FIGS. 20-21, it can be seen that the capacity retention for electrolytes 23 and 37 is comparable with that for the baseline electrolyte at low C-rates, while at higher C-rates, electrolyte 23 and 37 both exhibit higher capacity losses (electrolyte 23>electrolyte 37) compared to baseline electrolyte. Due to low capacity seen at C/1.5, higher C-rates were not attempted for electrolyte composition 23 in these measurements.

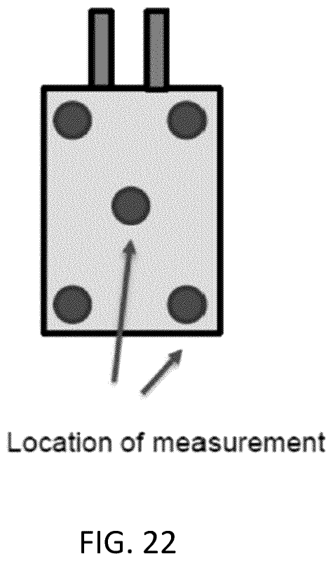

Tests were performed to measure capacity retention of the electrolyte compositions 23, 37, 38, and 39 compared to the baseline electrolyte composition after storage at high temperature. The experimental protocol was as follows: the pouch cells were subjected to 3 cycles at room temperature with C/10 charge and C/5 discharge prior to 60° C. assessment. The pouches were then charged to 4.2 V with a C/10 rate. The fully charged pouches were stored at 60° C. for one week. The pouches were then cooled to room temperature and after one hour the thickness of the pouch cell was measured at 5 positions. The cells were then discharged at room temperature at a rate of C/5. The entire cycle was repeated each week until only 60% of the original capacity remained or the cell expansion was greater than 50% of the original thickness. Referring to FIG. 22, the thickness of the cell was determined by sandwiching the cell between two glass slides and measuring at the four corners and in the center with microcalipers. The center thickness and the average thickness of all 5 measurements were monitored each week of the test.

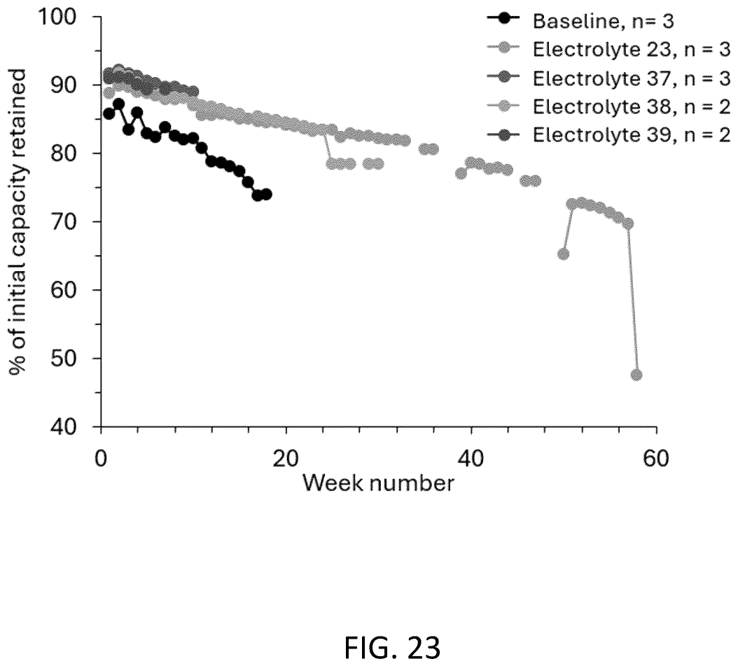

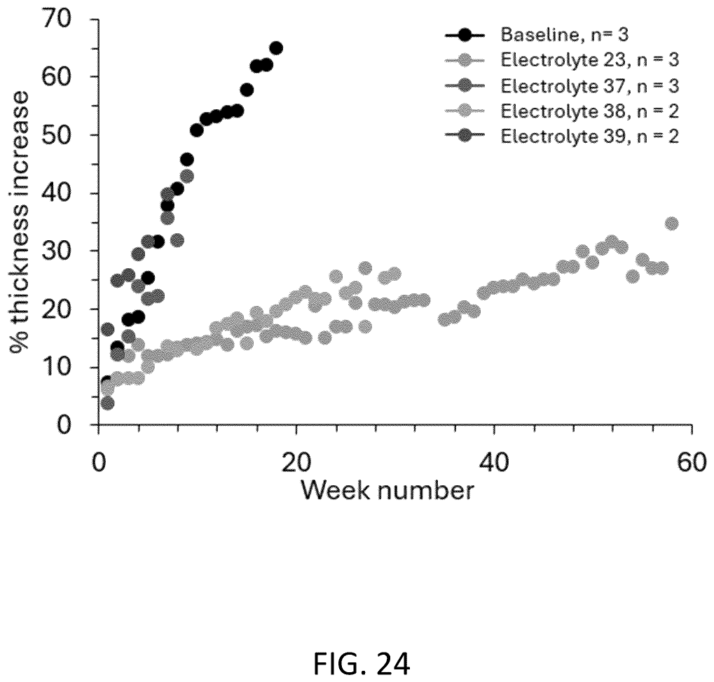

Data from the high temperature storage and discharge tests for the baseline composition from Table 3 and for electrolyte compositions 23, 37, 38, and 39 are shown in FIGS. 23 and 24. The plots show the percentage of initial capacity retained (FIG. 23) of the pouch cells at room temperature after each week stored fully charged at +60° C. The plot shows that electrolyte composition 23 performed better than the baseline composition in the capacity retention tests. Tests on the baseline composition and on electrolyte composition 39 were stopped after 18 weeks and 7 weeks, respectively, due to high cell expansion and pressure created on the pouch seals. It can be seen that it takes approximately 58 weeks for the pouch cells containing electrolyte composition 23 to exhibit 40% loss of the initial capacity. The thickness measurement results in FIG. 24 shows that there is a much lower degree of pouch swelling for electrolyte composition 23 (approximately 20% increase in thickness after 50 weeks) compared to the baseline electrolyte composition (approximately 70% increase in thickness in 18 weeks).

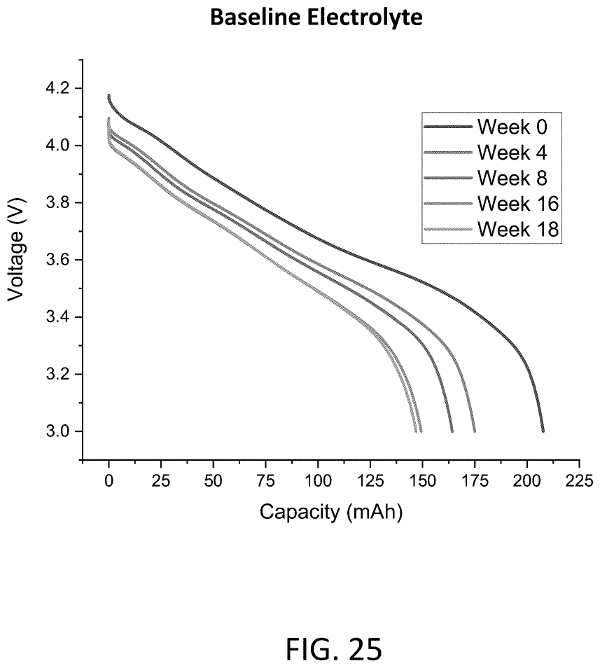

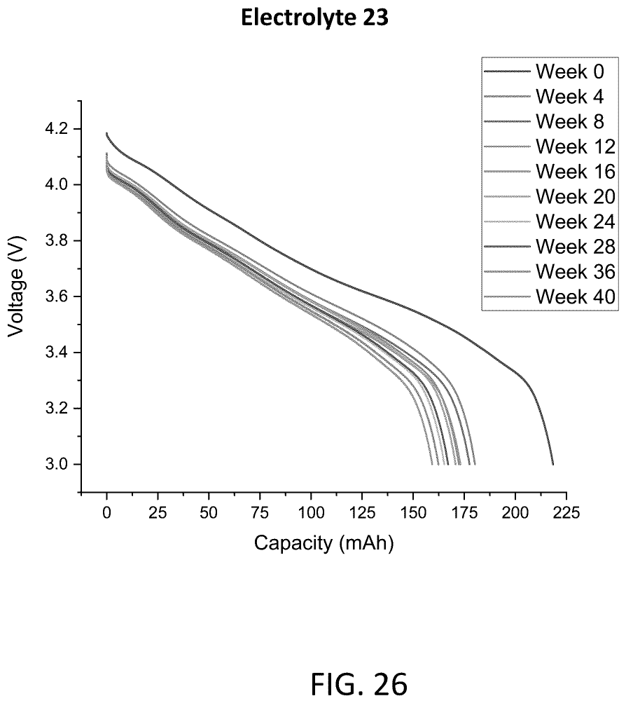

The comparison of the discharge profiles for the pouch cells containing the baseline electrolyte composition (FIG. 25) and electrolyte composition 23 (FIG. 26) measured with a C/5 rate at room temperature after each week of storage at 60° C., indicates similar level of polarization for both electrolyte composition 23 and the baseline electrolyte composition. However, the capacity loss (degradation rate) is higher for the baseline electrolyte composition than for electrolyte composition 23.

Test results provided in FIGS. 14-15 indicate that electrolyte composition 23 has particularly advantageous performance with respect to coulombic efficiency at room temperature, cycling performance at low temperature (−20° C.), and storage and discharge performance at high temperature (+60° C.).

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An electrolyte comprising:
1 wt % to 5 wt % of a first component comprising vinylene carbonate (VC); and
95 wt % to 99 wt % of a second component comprising a 0.5 M to 1.5 M solution of LiPF₆ in a mixture comprising:
ethyl methyl sulfone (EMS);
dimethyl sulfone (DMS);
ethylene carbonate (EC); and
ethyl methyl carbonate (EMC),
wherein a ratio of a total weight of EMS and DMS to a total weight of EC to a total weight of EMC is in a range of 1:1:5 to 2:2:10, and the EMS and DMS are present in a ratio of 80 mol % to 90 mol % of EMS to 20 mol % to 10 mol % of DMS.

2. The electrolyte of claim 1, wherein the electrolyte comprises 2 wt % of the first component and 98 wt % of the second component.

3. The electrolyte of claim 1, wherein the second component comprises a 1 M solution of LiPF₆ in the mixture.

4. The electrolyte of claim 1, wherein a ratio of EMS to DMS is 85:15 mol/mol.

5. The electrolyte of claim 1, wherein a ratio of a total volume of EMS and DMS to the total volume of EC is 1:1.

6. The electrolyte of claim 1, wherein a ratio of the total volume of EMS and DMS to the total volume of EMC is 1.5:7 wt/wt.

7. The electrolyte of claim 1, wherein a ratio of the total weight of EC to EMC is 1.5:7.

8. The electrolyte of claim 1, wherein a ratio of the total weight of EMS and DMS to a total weight of EC to a total weight of EMC is 1.5:1.5:7.

9. The electrolyte of claim 1, further comprising a wetting agent.

10. The electrolyte of claim 9, wherein the wetting agent comprises a fluorinated ether.

11. The electrolyte of claim 10, wherein the fluorinated ether comprises 1,1,2,2-tetrafluoroethyl-2,2,3,3-tetrafluoropropyl ether.

12. A lithium-ion battery comprising the electrolyte of claim 1.
